(19) United States
(12) Patent Application Publication
(10) Pub. No.: US 2006/0256281 A1
(43) Pub. Date: Nov. 16, 2006

(54) Spectacles set with decorative frame

(76) Inventor: Xin Liang Li, Pomona, CA (US)

Correspondence Address: Raymond Y. Chan, Suite 128, 108 N. Ynez Avenue, Monterey Park, CA, 91754, US

(21) Appl. No.: 11/488,213

(22) Filed: Jul. 17, 2006

Related U.S. Application Data
(63) Continuation-in-part of application No. 11/004,112, filed on Dec. 3, 2004.

(51) Int. Cl. G02C 7/08

(52) U.S. Cl. 351/57

(57) ABSTRACT

A spectacles set includes a lens frame, a decorative frame and a lens engaging arrangement. The lens frame includes two lenses and a lens retention arrangement spacedly supporting the two lens in position. The decorative frame includes two lens rims defining two lens areas respectively, a bridge extending between two inner sides of the lens rims, and two side extensions extending at two outer sides of the lens rims. The lens engaging arrangement is provided at a rear side of the decorative frame to detachably engaging with the lens frame at a position that when the lens retention arrangement is detachably mounted at the rear side of the decorative frame in a hidden manner, the two lenses are alignedly positioned at two lens areas respectively so as to keep an aesthetic appearance of the decorative frame with the two lenses.

### CROSS REFERENCE OF RELATED APPLICATION

This is a Continuation-In-Part application that claims the benefit of priority under 35U.S.C.§119 to a non-provisional application, application Ser. No. 11/004,112, filed Dec. 03, 2004.

### BACKGROUND OF THE PRESENT INVENTION

1. Field of Invention

The present invention relates to spectacles, and more particularly to a spectacle set which comprises at least a decorative frame detachably mounting two lenses in position so as to allow the wearer to interchange the spectacle frame.

2. Description of Related Arts

A conventional spectacle generally comprises two lenses and a spectacle frame for supporting the lenses in position, wherein the spectacle frame comprises two side extensions rearwardly extended from two outer sides of the lenses respectively for wearing onto the ears of the user, and a bridge extended between two inner sides of the lenses for supporting the lenses at a predetermined position above the user's nose.

Specifically, the spectacle frame comprises two lens rims for respectively encircling the two lenses wherein the bridge is extended between two inner sides of the lens rims and the two side extensions are respectively extended from two outer sides of the lens rims.

As a matter of fact, the two lenses are securely mounted within the two lenses respectively such that the two lenses are permanently affixed to the spectacle frame. However, such structural configuration of the spectacle frame has several drawbacks.

Nowadays, most spectacle designers design different ornamental designs of the spectacles to enhance the aesthetic appearance thereof since spectacles are considered as one of the fashionable objects for the wearers. Therefore, most wearers usually purchase more than one spectacles to mix and match with their fashionable style. It is worth to mention that such spectacles are prescription glasses such that optometrists suggest that every wearer should have an eye examination for every two years. It is costly that the wearers must pay for another set of fashionable spectacles once the prescription glasses must be changed.

Furthermore, the conventional spectacle is difficult to clean in detail since the lenses are permanently affixed to the spectacle frame. Accordingly, the wearer can only clean up the two surfaces of each of the lenses by rubbing since the encircling edge of each lens is mounted at the lens rim. Therefore, the dirt will be accumulated within a gap between the encircling edge of the lens and the lens rim. However, when the wearer tries to clean the dirt within the gap, the lens may be forced to detach from the spectacle frame accidentally and even the structure of the spectacle frame will be distorted. Due to the precise configuration of the spectacle frame, the lens cannot be tightly secured to the spectacle frame again once the lens is detached from the spectacle frame.

### SUMMARY OF THE PRESENT INVENTION

A main object of the present invention is to provide a spectacle set which comprises at least a decorative frame detachably mounting two lenses in position so as to allow the wearer to interchange the decorative frame.

Another object of the present invention is to provide a spectacle set, wherein the lenses are securely mounted to the decorative frame in a toolless manner. In other words, no tool is required to detachably mount the lenses to the decorative frame.

Another object of the present invention is to provide a spectacle set, which does not need to alter its original structural design for fitting the lenses. In other words, from the user's perspective, the cost for utilizing the decorative frame can be minimized.

Another object of the present invention is to provide a spectacle set, wherein the detachably mounting operation of the lens is simple that the wearer is able to complete the operation in minutes.

Another object of the present invention is to provide a spectacle set, wherein no expensive or complicated mechanical structure is required to employ in the present invention in order to achieve the above mentioned objects. Therefore, the present invention successfully provides an economic and efficient solution not only for providing a decorative frame to substantially support the lenses in position but also for configuring an interchangeable decorative frame that the wearer is able to interchange the decorative frame to fit the lens, especially for the prescription glasses.

Another object of the present invention is to provide a spectacles set comprising a lens frame and a decorative frame, wherein two lenses mounted in the lens frame are adapted to be detachably retained on a rear side of the decorative frame for allowing the user to pick an optimal decorative frames in different situations.

Another object of the present invention is to provide a spectacles set comprising a lens frame and a decorative frame which can be embodied as a wide variety of frame types (e.g. a plastic decorative frame or a metallic decorative frame) so as to suit user's different needs.

Accordingly, in order to accomplish the above objects, the present invention provides a spectacles set, comprising:

a lens frame which comprises two lenses and a lens retention arrangement spacedly supporting the two lens in position;

at least a decorative frame, which comprises two lens rims defining two lens areas respectively, a bridge extending between two inner sides of the lens rims, and two side extensions extending at two outer sides of the lens rims; and

a lens engaging arrangement provided at a rear side of the decorative frame to detachably engaging with the lens frame at a position that when the lens retention arrangement is detachably mounted at the rear side of the decorative frame in a hidden manner, the two lenses are alignedly positioned at two lens areas respectively so as to keep an aesthetic appearance of the decorative frame with the two lenses.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a spectacle set according to a first preferred embodiment of the present invention.

FIG. 2 is a partially perspective view of the spectacle set according to the above first preferred embodiment of the present invention.

FIG. 3 illustrates an alternative mode of the fastening means of the spectacle set according to the above first preferred embodiment of the present invention.

FIG. 4 is a perspective view of a spectacle set according to a second preferred embodiment of the present invention.

FIG. 5 is a sectional view of the spectacle set according to the above second preferred embodiment of the present invention.

FIG. 6 is a perspective view of a spectacle set according to a third preferred embodiment of the present invention.

FIG. 7 is a sectional view of the spectacle set according to the above third preferred embodiment of the present invention.

FIG. 8 illustrates an alternative mode of the spectacle set according to the above third preferred embodiment of the present invention.

FIG. 9 is a perspective view of a spectacle set according to a fourth preferred embodiment of the present invention.

FIG. 10 is a perspective view of a spectacle set according to a fifth preferred embodiment of the present invention.

FIGS. 11A and 11B are sectional view of the fastening means of the spectacle set according to the above fifth preferred embodiment of the present invention.

FIG. 12 is a perspective view of a spectacle set according to a sixth preferred embodiment of the present invention.

FIGS. 13A and 13B are perspective views of the fastening means of the spectacle set according to the above sixth preferred embodiment of the present invention.

FIG. 14 is a perspective view of a spectacle set according to a seventh preferred embodiment of the present invention.

FIG. 15 is a sectional view of the fastening means of the spectacle set according to the above seventh preferred embodiment of the present invention.

FIG. 16 is a perspective view of a spectacle set according to an eighth preferred embodiment of the present invention.

FIG. 17 is a sectional view of the fastening means of the spectacle set according to the above eighth preferred embodiment of the present invention.

FIG. 18 illustrates an application of the spectacle set according to the above first through eighth embodiments of the present invention.

FIG. 19 illustrates another application of the spectacle set according to the above first through eighth embodiments of the present invention.

FIG. 20 is a perspective view of the spectacles set according to a ninth preferred embodiment of the present invention.

FIG. 21 is a side view of the spectacles set according to the above ninth preferred embodiment of the present invention.

FIG. 22 is a first alternative mode of the spectacles set according to the above ninth preferred embodiment of the present invention.

FIG. 23 is a schematic diagram of the first alternative mode of the spectacles set according to the above ninth preferred embodiment of the present invention

FIG. 24 is a second alternative mode of the spectacles set according to the above ninth preferred embodiment of the present invention.

FIG. 25 is a schematic diagram of the second alternative mode of the spectacles set according to the above ninth preferred embodiment of the present invention.

FIG. 26 is a perspective view of the spectacles set according to a tenth preferred embodiment of the present invention.

FIG. 27 is a schematic diagram of the spectacles set according to the above tenth preferred embodiment of the present invention.

FIG. 28 is a sectional side view of the spectacles set according to the above tenth preferred embodiment of the present invention.

### DETAILED DESCRIPTION OF THE PREFERRED EMBODIMENT

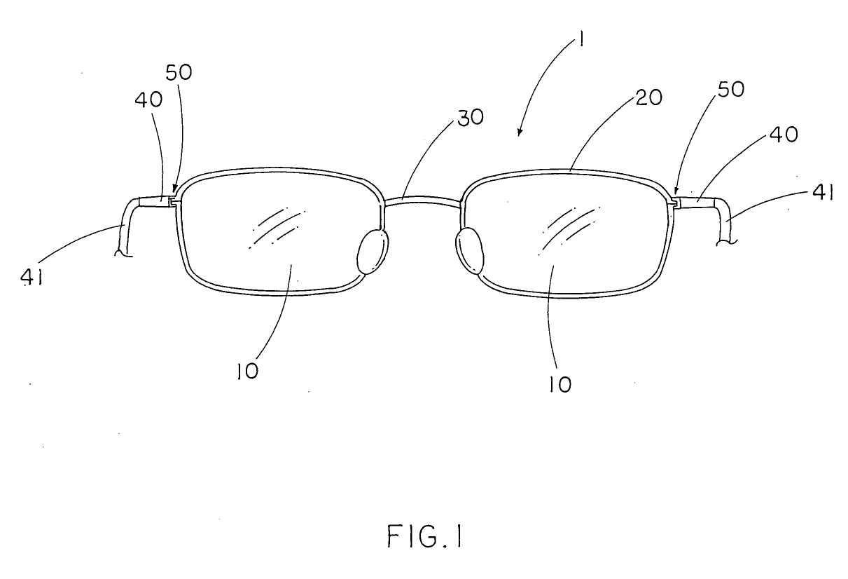

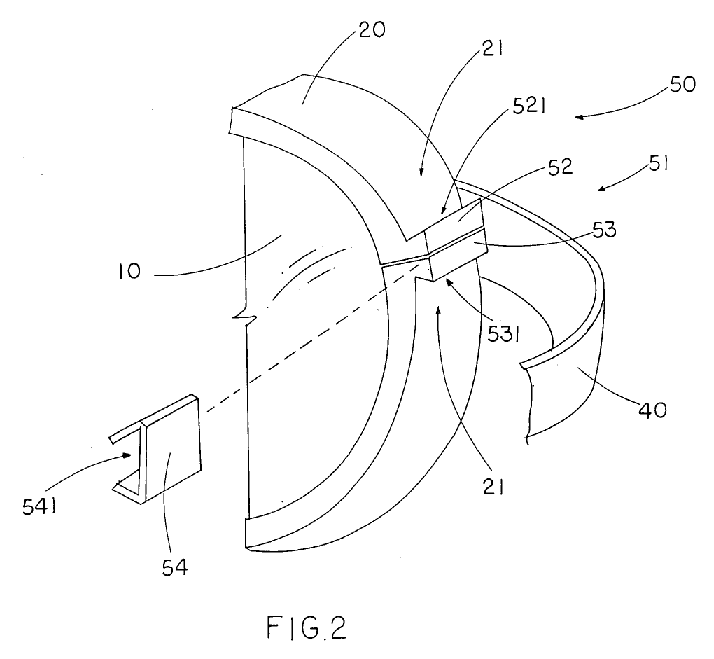

Referring to FIG. 1 to FIG. 2 of the drawings, a spectacle set according to a first embodiment of the present invention is illustrated, wherein the spectacle set comprises at least a decorative frame 1 for supporting two lenses 10 in position.

The decorative frame 1 comprises two lens rims 20, a bridge 30 extended between two inner sides of the lens rims 20, two side extensions 40 provided at two outer sides of the lens rims 20 for coupling a pair of temples 41 respectively, and a free-hand securing device 50 detachably mounting the two lenses 10 on the lens rims 20 respectively in a toolless manner.

According to the first embodiment, each of the lens rims 20 is shaped and sized corresponding to the lens 10 wherein each of the lens rims 20 having a C-shape has two free ends 21 arranged in such a manner that when the two free ends 21 are aligned with each other, the lens rim 20 form a circular structure to encircle a peripheral edge of the respective lens 10. The securing device 50 is provided at the free ends 21 of each of the lens rims 20 to connect said the free ends 21 of the lens rim 20 to form the circular structure. Preferably, the two free ends 21 of each of the lens rims 20 are formed at the outer side thereof at a position aligning with the respective side extension 40 so as to enhance the aesthetic appearance of the decorative frame 1.

As shown in FIG. 2, the securing device 50 comprises a rim lock 51 having an upper locking body 52 provided at one of the free ends 21 of the lens rim 20 and a lower locking body 53 provided at another free end 21 of the respective lens rim 20, and a detachable locker 54 slidably fastened the upper locking body 52 with the lower locking body 53 in a detachably connecting manner so as to connect the two free ends 21 of the lens rim 20.

Accordingly, the detachable locker 54 having a C-shaped cross section has a mounting groove 541 wherein the upper and lower locking bodies 52, 53 of the rim lock 51 are fittingly received in the mounting groove 541 to connect the two free ends 21 of the lens rim 20 to form the circular structure so as to retain the respective lens 10 in position. In other words, when the upper locking body 52 is overlapped on the lower locking body 53, the detachable locker 54 is transversely slid to engage with the rim lock 51 to receive the upper and lower locking bodies 52, 53 within the mounting groove 541.

The upper locking body 52 has an upper slanted surface 521 and the lower locking body 53 has a lower slanted surface 531 such that when the upper locking body 52 is overlapped on the lower locking body 53, a thickness of the rim lock 51 is gradually reduced towards the lens rim 20. As shown in FIG. 2, the mounting groove 541 of each of the detachable lockers 54 has a width gradually reducing towards an opening thereof to fit the rim lock 51 in the mounting groove 541 of the detachable locker 54.

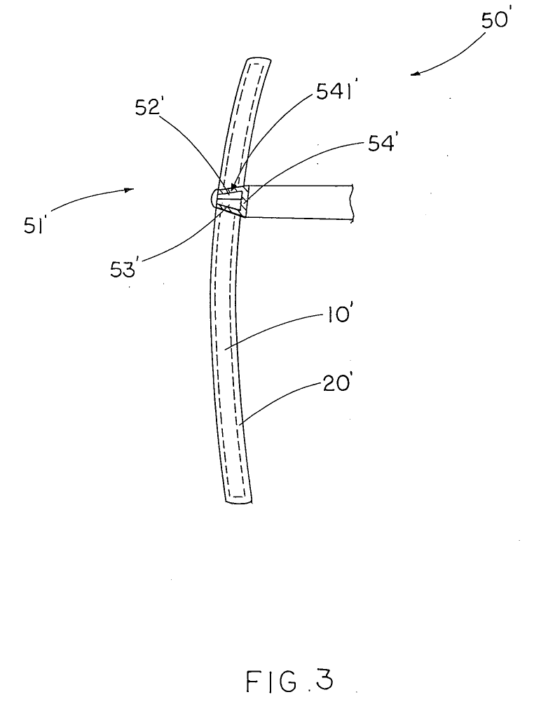

FIG. 3 illustrates an alternative mode of the securing device 50′ wherein the upper locking body 52′ is overlapped on the lower locking body 53′ to form the rim lock 51′ having a thickness gradually reducing from a rear end to a front end. The mounting groove 541′ of the detachable locker 54′ has a width gradually towards a front opening such that the detachable locker 54′ is sidewardly slid to engage with the rim lock 51′ to receive the upper and lower locking bodies 52′, 53′ within the mounting groove 541′ so as to hold the lens 10′ within the respective lens rim 20′.

It is worth to mention that the upper locking body 52 can be overlapped with the lower locking body 53 side-by-side such that the detachable 54 is downwardly slid to engage with the rim lock 51 to receive the upper and lower locking bodies 52, 53 within the mounting groove 541.

In order to securely mount the lenses 10 to the decorative frame 1, the wearer is able to encirlingly position two lenses 10 within the lens rims 20 respectively wherein a pressing force is applied at the two free ends 21 of each of the lens rims 20 until the upper locking body 52 is overlapped the lower locking body 53. Therefore, the wearer is able to slide the detachable locker 54 to receive the rim lock 51 therein to securely connect the two free ends 21 of the lens rim 20 with each other to form the circular structure so as to substantially encircle the peripheral edge of the respective lens 10 within the lens rim 20. In other words, the wearer is able to interchange the decorative frame 1 without replacing the lenses 10, especially for prescription glasses. Accordingly, the wearer can own two or more decorative frames 1 with different styles such that the wear is able to interchange the decorative frames 1 with the same lenses 10 incorporating therewith.

For detaching the lenses 10 from the decorative frame 1, the wearer can simply slide the detachable locker 54 to release the engagement between the upper and lower locking bodies 52, 53 such that the free ends 21 of the lens rim 20 are free to move for detaching the respective lens 10 from the lens rim 20. It is worth to mention that no tool, such as screw driver, is required to secure the lenses 10 to or detach the lenses 10 from the decorative frame 1 through the sliding engagement between the rim lock 51 and the detachable locker 54. Once the lens 10 is detached from the decorative frame 1, the wearer is able to clean the lenses 10 and the decorative frame 1 individually without distorting the structure of the decorative frame 1.

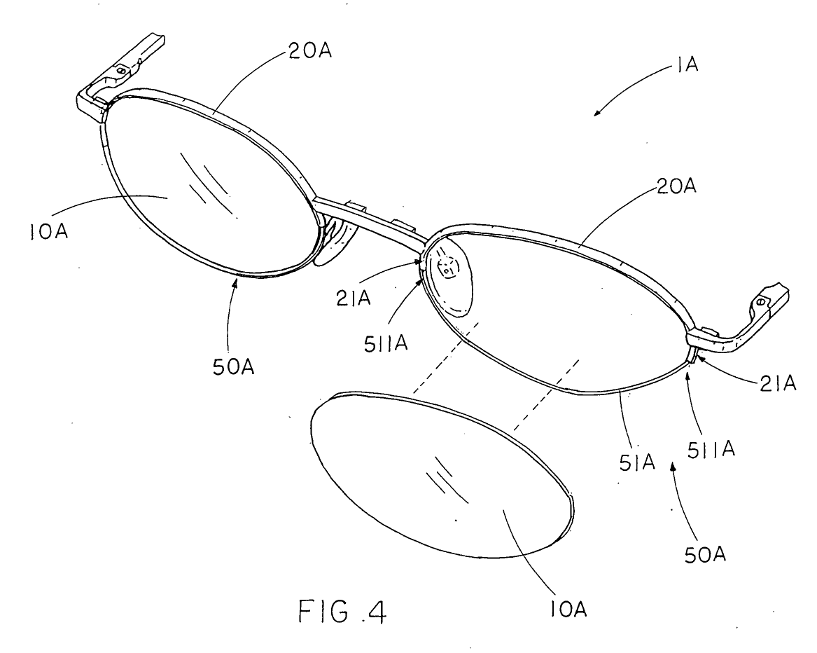

As shown in FIG. 4, a decorative frame IA of a second embodiment illustrates an alternative mode of the first embodiment of the present invention, wherein each of the lens rims 20A having a C-shape has two free ends 21A to encircle a portion of a peripheral edge of the respective lens 10A.

The securing device 50A comprises an elastic fastening string 51A having two securing ends 511 substantially fastening at the two free ends 21A of each of the lens rims 20A for applying an urging force against the peripheral edge of the respective lens 10A so as to form a circular structure to encircle the peripheral edge of the respective lens 10A.

As shown in FIG. 4, each of the lens rims 20A forms an upper rim to encircle an upper peripheral edge of the respective lens 10A and the elastic fastening string 51A fastened with the respective lens rim 20A to form a lower rim to apply the urging force against a lower peripheral edge of the respective lens 10A so as to encircle the lower peripheral edge of the respective lens 10A.

Accordingly, the elastic fastening string 51A is made of elastic material adapted to stretchably extend a length between the two securing ends 511A of the elastic fastening string 51A so as to adjust a circumferential size of the circular structure.

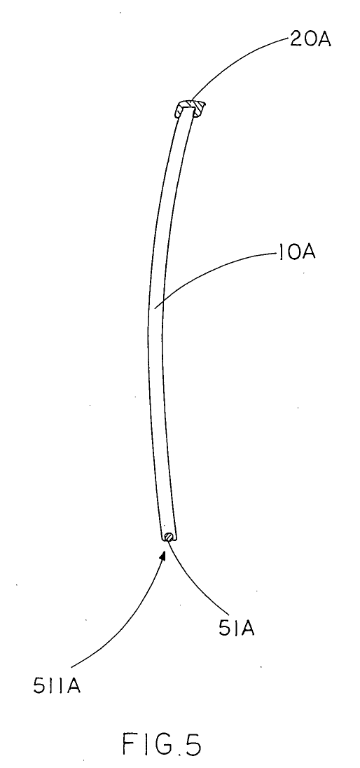

Each of the lenses 10A further has a retaining groove 11A formed along the lower peripheral edge of the lens 10A wherein the elastic fastening string 511A is slidably received in the retaining groove 11A to substantially retain the lens 10A in position, as shown in FIG. 5. In other words, when the elastic fastening string 51A received along the retaining groove 11A, the elastic fastening string 51A substantially encircles the lower peripheral edge of the lens 10A.

In order to securely mount the lenses 10A to the decorative frame 1A, the wearer is able to fit the upper peripheral edge of the lens 10A to the respective lens rim 20A and to apply a pulling force at the elastic fastening string 51A to stretch the length thereof so as to encircle the lower peripheral edge of the lens 10A. In other words, each of the lenses 10A is encircled within the respective lens rim 20A and the elastic fastening string 51A. Therefore, no tool is required to mount the lenses 10A onto or detach the lenses 10A from the decorative frame 1A through the elastic engagement of the elastic fastening string 51A.

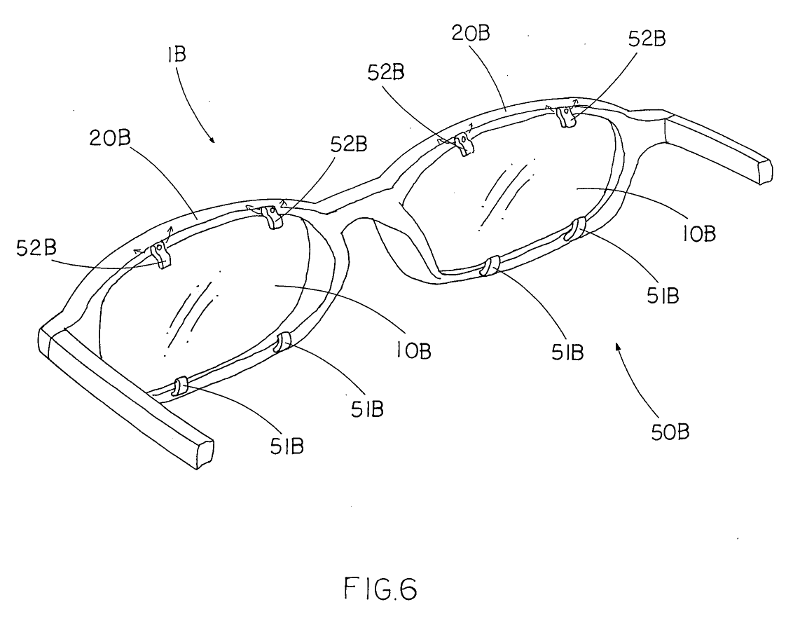

As shown in FIG. 6, a decorative frame 1B of a third embodiment illustrates another alternative mode of the first embodiment of the present invention, wherein each of the lens rims 20B is shaped and sized corresponding to the lens 10B such that each of the lens rims 20B forms a circular structure to encircle the respective lens 10B.

The securing device 50B comprises at least a supporting member 51B upwardly extended at a lower portion of each of the lens rims 20B for supporting a lower peripheral edge of the lens 10B and at least a retaining member 52B pivotally formed at an upper portion of each of the lens rims 20B for retaining an upper peripheral edge of the lens 10B in position, so as to substantially encircle the lens 10B within the respective lens rim 20B.

Preferably, two supporting member 51B are rearwardly and spacedly extended from a rear side of the respective lens rim 20B at the lower portion thereof and two retaining member 52B are rearwardly and spacedly extended from the rear side of the respective lens rim 20B at the upper portion thereof, as shown in FIG. 6.

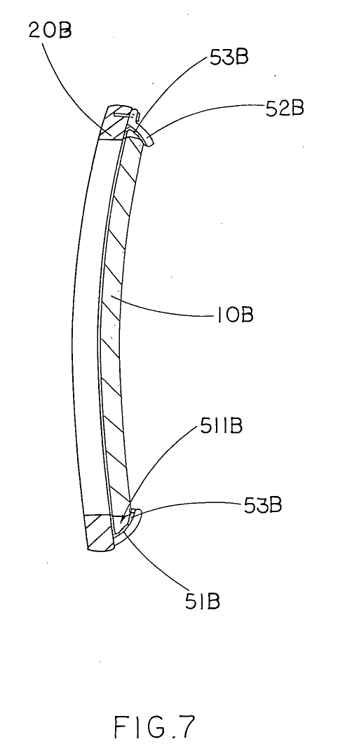

Accordingly, the supporting member 51B is rearwardly extended from the rear side of the respective lens rim 20B to define a supporting groove 511B between the supporting member 51B and the rear side of the lens rim 20B for the lower peripheral edge of the lens 10B receiving in the supporting groove 511 B. The supporting member 51B is inclinedly extended from the rear side of the lens rim 20B such that a width of the supporting groove 511B is gradually increasing towards an upper opening thereof, as shown in FIG. 7. Therefore, the lenses 20B with varying thicknesses can fit into the supporting groove 511B without altering the structure of the supporting member 51B.

The retaining member 52B is pivotally mounted to the rear side of the respective lens rim 20B at the upper portion thereof, wherein the retaining member 52B is adapted to pivotally fold to bias against the upper peripheral edge of the lens 10B at a rear side thereof to substantially hold the lens 10B at the lens rim 20B and to pivotally fold offset to the upper peripheral edge of the lens 10B such that the lens 10B is adapted to be detached from the lens rim 20B.

The securing device 50B further comprises a protective layer 53B formed at an inner side of each of the supporting member 51B and the retaining member 52B to protect the peripheral edge of the lens 10B. Accordingly, when the lens 10B is mounted at the respective lens rim 20B, the supporting member 51B and the retaining member 52B may scratch on the lens 10B accidentally during the mounting operation. The protective layer 53B, which is made of anti-scratching material such as rubber or plastic, is formed at each inner side of the supporting member 51B and the retaining member 52B to prevent the lens 10B from being scratched by the supporting member 51B and the retaining member 52B. In addition, the protective layer 53B can also provide a friction between the lens 10B and the lens rim 20B to substantially hold the lens 10B in position.

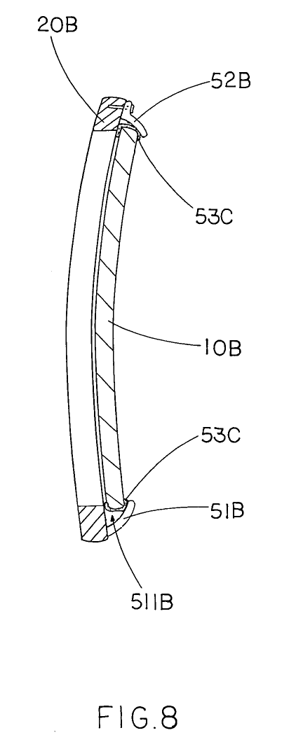

FIG. 8 illustrates an alternative mode of the protective layer 53C which encircles around the peripheral edge of the lens 10B such that when the lens 10B is mounted to the respective lens rim 20B, the protective layer 53C prevents the lens 10B from being scratched by the supporting member 51 B and the retaining member 52B.

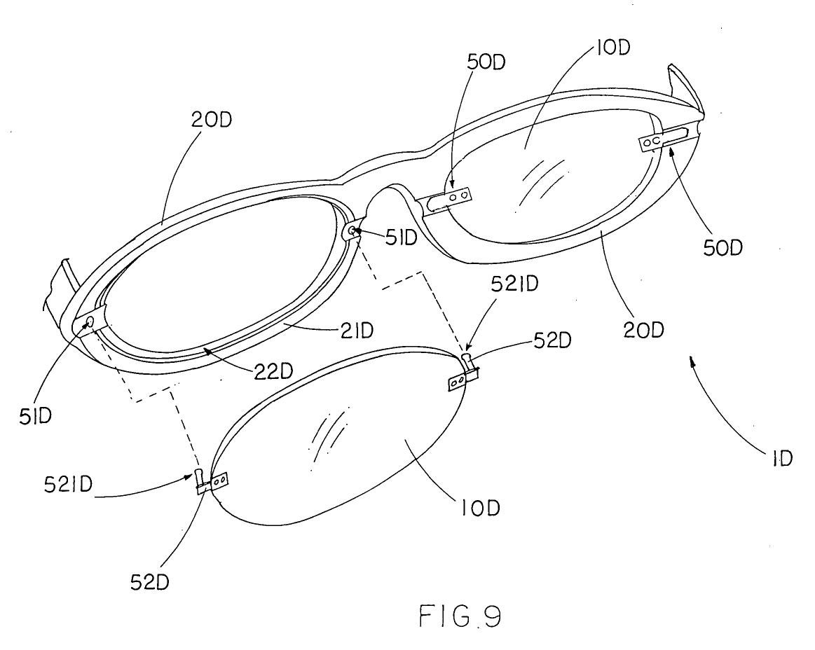

As shown in FIG. 9, a decorative frame ID of a fourth embodiment illustrates another alternative mode of the first embodiment of the present invention, wherein each of the lens rims 20D is shaped and sized corresponding to the lens 10D such that each of the lens rims 20D forms a circular structure to encircle the respective lens 10D. Each of the lens rims 20D having a L-shape cross section has a surrounding rim 21D encircling a peripheral edge of the respective lens 10D and a retaining rim 22D biasing against a rear side of the respective lens 10D.

The securing device 50D contains two holding grooves 51D formed on the inner side and the outer side of each of the lens rims 20D respectively and comprises two fastening elements 52D rearwardly extended from the inner side and the outer side of each of the lens 10D to align with the two holding grooves 51D respectively, wherein when the four fastening elements 52D are slidably inserted into the four holding grooves 51D respectively in a detachably connecting manner, the two lens 10D are securely mounted at the two lens rims 20D respectively.

Accordingly, each of the fastening elements 52D is directly fastened at the peripheral edge of the lens 10D to align with the respective holding groove 51 D on the lens rim 20D, wherein each of the fastening elements 52D, which is made of elastic material, has an enlarged head portion 521D having a size slightly larger than a size of the holding groove 51D such that when the head portions 521D of the fastening elements 52D are slidably pressed into the holding grooves 51D respectively, the lenses 10D are substantially mounted at the lens rims 20D in position. It is worth to mention that the wearer is able to apply a pulling force at the lens 10D to slidably pull the head portion 521D of the fastening element 52D out of the respective holding groove 51D so as to detach the lens 10D from the lens rim 20D.

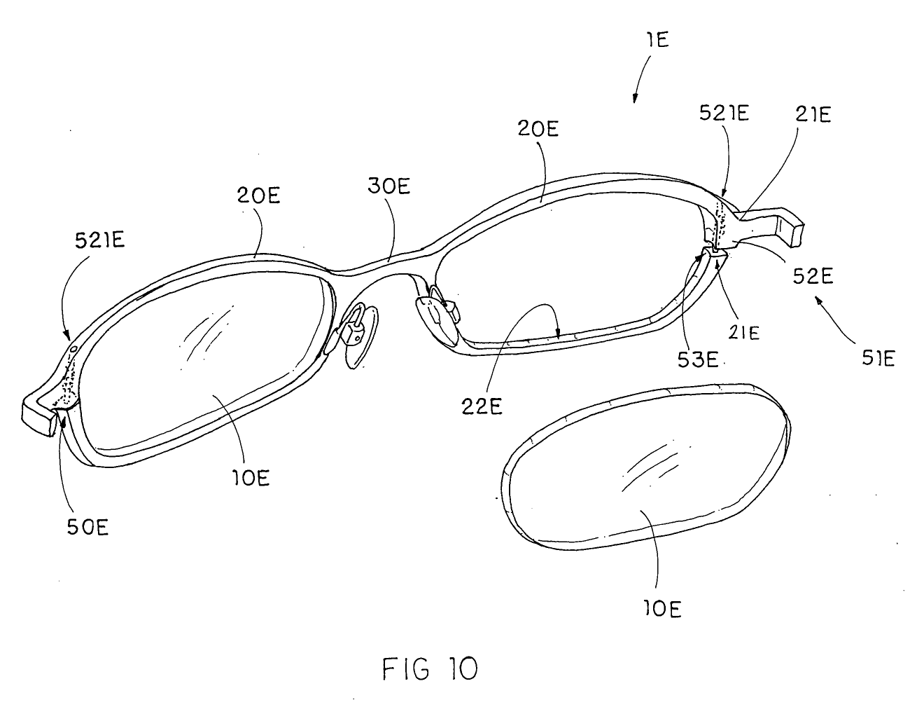

As shown in FIG. 10, a spectacle set of a fifth embodiment illustrates another alternative mode of the first embodiment of the present invention, wherein the spectacle set comprises at least a decorative frame 1E for supporting two lenses 10E in position. The decorative frame 1E comprises two lens rims 20E and a bridge 30E extended therebetween, wherein each of the lens rims 20E having a C-shape has two free ends 21E arranged in such a manner that when the two free ends 21E are aligned with each other, the lens rim 20E form a circular structure to encircle a peripheral edge of the respective lens 10E.

The securing device 50E is provided at the free ends 21E of each of the lens rims 20E to connect said the free ends 21E of the lens rim 20E to form the circular structure. Preferably, the two free ends 21E of each of the lens rims 20E are formed at the outer side thereof at a position aligning with the respective side extension 40E so as to enhance the aesthetic appearance of the decorative frame 1E.

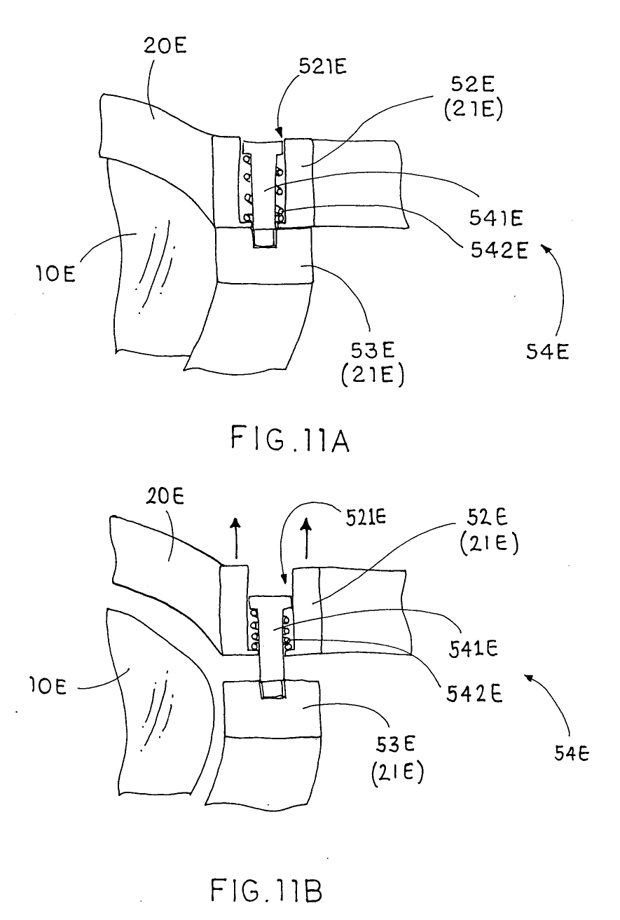

As shown in FIG. 11A, the securing device 50E comprises a rim lock 51E having an upper locking body 52E provided at one of the free ends 21E of the lens rim 20E and a lower locking body 53E provided at another free end 21E of the respective lens rim 20E, and a slider locker 54E affixed to the lower locking body 53E to slidably engage with the upper locking body 52E so as to connect the two free ends 21E of the lens rim 20E.

Accordingly, the upper locking body 52E, which is integrally extended from the respective free end 21E of the rim lock 20E, has a sliding slot 521E extending towards to the lower locking body 53E, wherein the slider locker 54E comprises a locker pin 541E having an enlarged head slidably disposed in the sliding slot 521E and an affixed end affixed to the lower locking body 53E, and a resilient element 542E disposed in the sliding slot 521E for applying an urging force against the enlarged head of the locker pine 541E to push the lower locking body 53E towards the upper locking body 52E so as to connect the two free ends 21E of the lens rims 20 to hold the lens 10E in position.

The resilient element 542E is embodied as a compression spring disposed in the sliding slot 521E of the upper locking body 52E wherein the resilient element 542E has two ends biasing against the enlarged head of the locker pin 541E and a bottom wall of the sliding slot 521E to normally push the lower locking body 53E towards the upper locking body 52E. Accordingly, in order to detach the lens 10E from the respective lens frame 20E, the user is able to stretch the lens frame 20E to pull the upper locking body 52E apart from the lower locking body 53E while the enlarged head of the locker pin 541E is slid into the sliding slot 521E to compress the resilient element 542E as shown in FIG. 11B.

Accordingly, each of the lens rims 20E further has a holding groove 22E formed along an inner peripheral edge thereof to receive the peripheral edge of the respective lens 10E when the lens 10E is retained within the lens rims 20E.

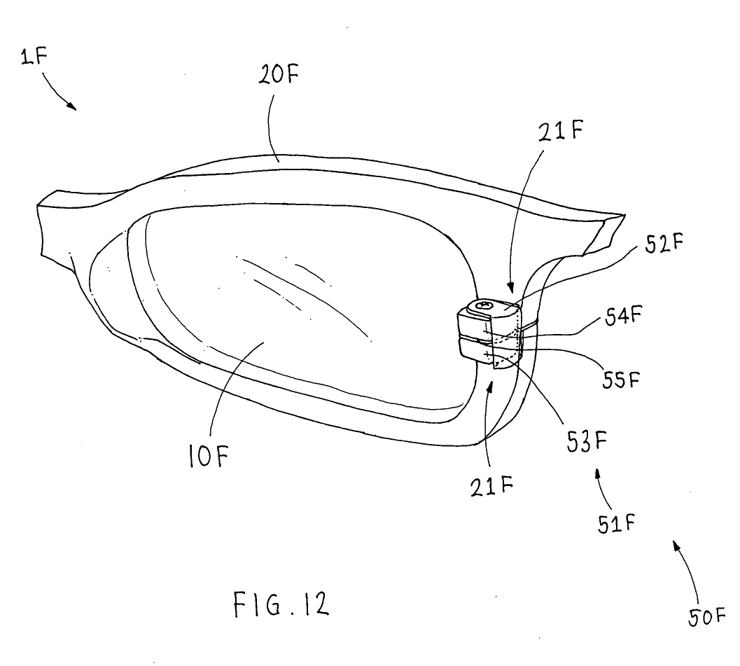

As shown in FIG. 12, a spectacle set of a sixth embodiment illustrates another alternative mode of the first embodiment of the present invention, wherein the decorative frame 1F, having the same structure of the first embodiment expect the securing device 50F, comprises two lens rims 20F to hold the lenses 10F in position.

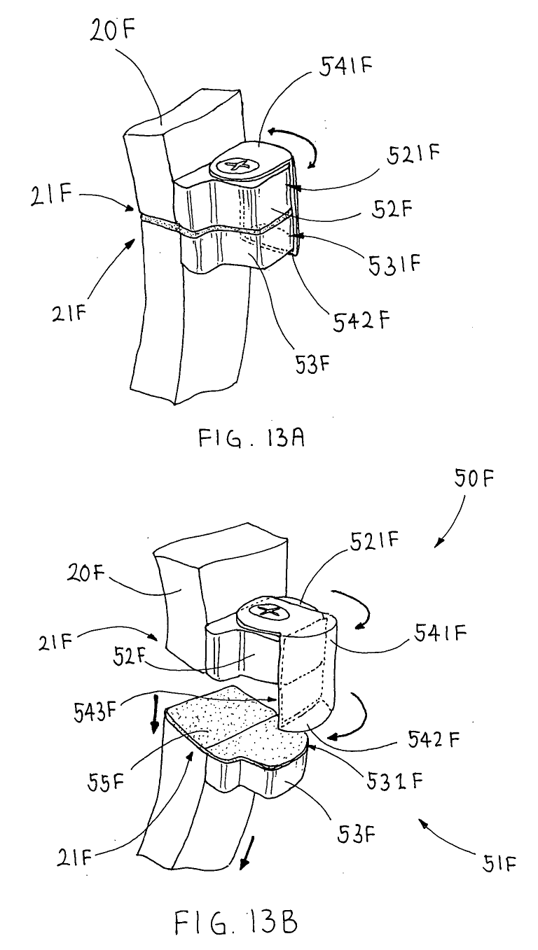

The securing device 50F is provided at the free ends 21F of each of the lens rims 20F to connect said the free ends 21F of the lens rim 20F to form the circular structure. As shown in FIG. 13, the securing device 5OF comprises a rim lock 5IF having an upper locking body 52F provided at one of the free ends 21F of the lens rim 20F and a lower locking body 53F provided at another free end 21F of the respective lens rim 20F, and a slider locker 54F affixed to the upper locking body 52F to slidably engage with the lower locking body 53F so as to connect the two free ends 21F of the lens rim 20F.

According to the sixth embodiment, the slider locker 54F comprises a top platform 541F rotatably mounted on the upper locking body 52F and a bottom platform 542F defining a locking cavity 543F between the top and bottom platforms 541F, 542F wherein the slider locker 54F is rotatably slid to lock up the upper locking body 52F with the lower locking body 53F when the bottom platform 542F is slid to engage with the lower locking body 53F to receive the upper and lower locking bodies 52F, 53F within the locking cavity 543F, as shown in FIGS. 13A and 13B.

As shown in FIG. 13A, the upper locking body 52F has an upper protrusion portion 521F and the lower locking body 53F has a lower protrusion portion 531F shaped and sized corresponding to the upper protrusion portion 521F wherein the slider locker 54F is slid to receive the upper and lower protrusion portions 521F, 531F within the locking cavity 543F to lock up the upper locking body 52F with the lower locking body 53F.

The securing device 5OF further comprises a reinforcing layer 55F sandwiched between the upper and lower locking bodies 52F, 53F to reinforce an engagement therebetween. Accordingly, the reinforcing layer 55F is made of rubber or plastic to prevent an unwanted movement of each of upper and lower locking bodies 52F, 53F when the slider locker 541F is rotatably slid to lock up the upper locking body 52F with the lower locking body 53F so as to prevent the lens 10F from being scratched by the rim lock 51F accidentally.

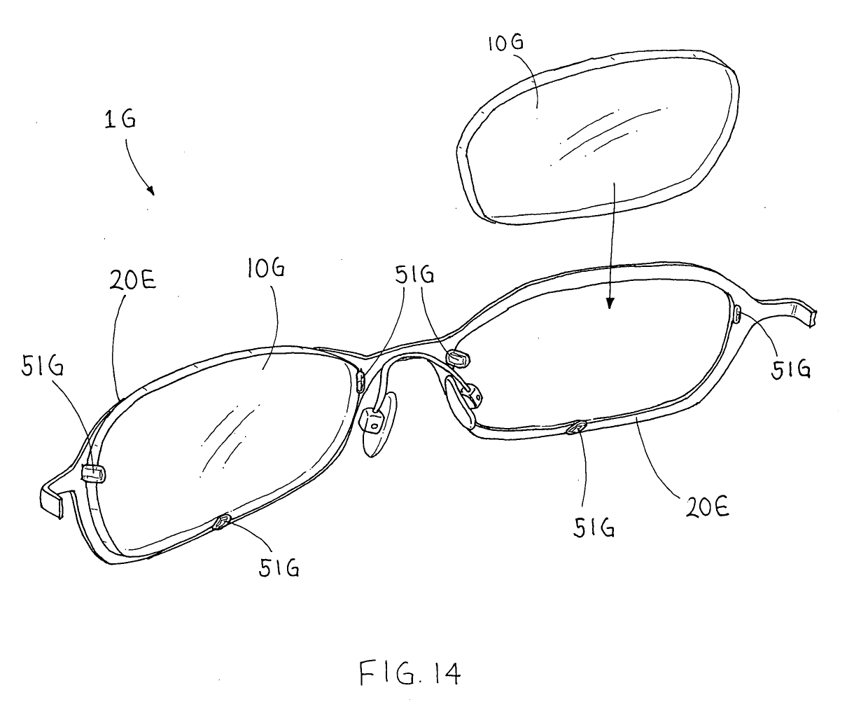

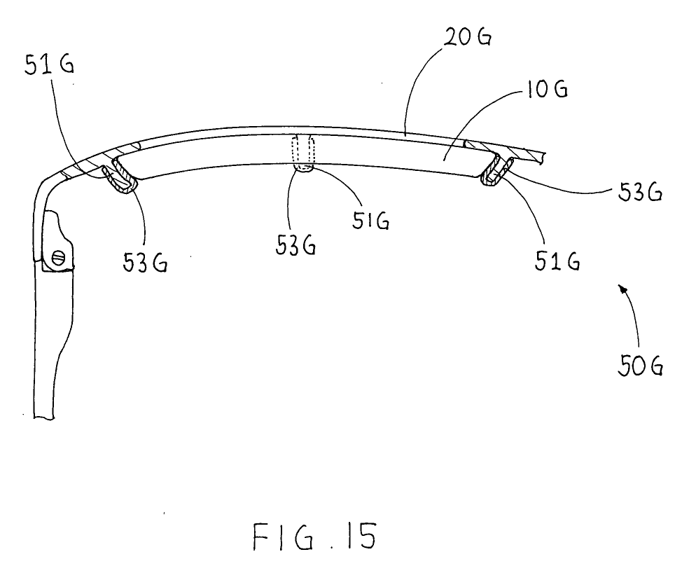

As shown in FIGS. 14 and 15, a spectacle set of a seventh embodiment illustrates another alternative mode of the third embodiment of the present invention, wherein the decorative frame 1G, having the same structure of the first embodiment expect the securing device 50G, comprises two lens rims 20G to hold the lenses 10G in position.

The securing device 50G comprises at least three supporting members 51G providing at two side peripheral edges and a lower peripheral edge of each of the lens rims 20G respectively wherein the supporting members 51G are inwardly extended from the rear side of the lens rim 20G to securely hold the respective lens 10G within the lens rim 20G. Accordingly, the three supporting members 51G are biased against two side peripheral edges and a lower peripheral edge of the respective lens 10G such that the lens 10G can be dropped down and mounted within the lens rim 20G to enhance the mounting operation of the lens 10G.

The securing device 50G further comprises a protective layer 53G formed at an inner side of each of the supporting members 51G to protect the peripheral edge of the lens 10G, as shown in FIG. 15.

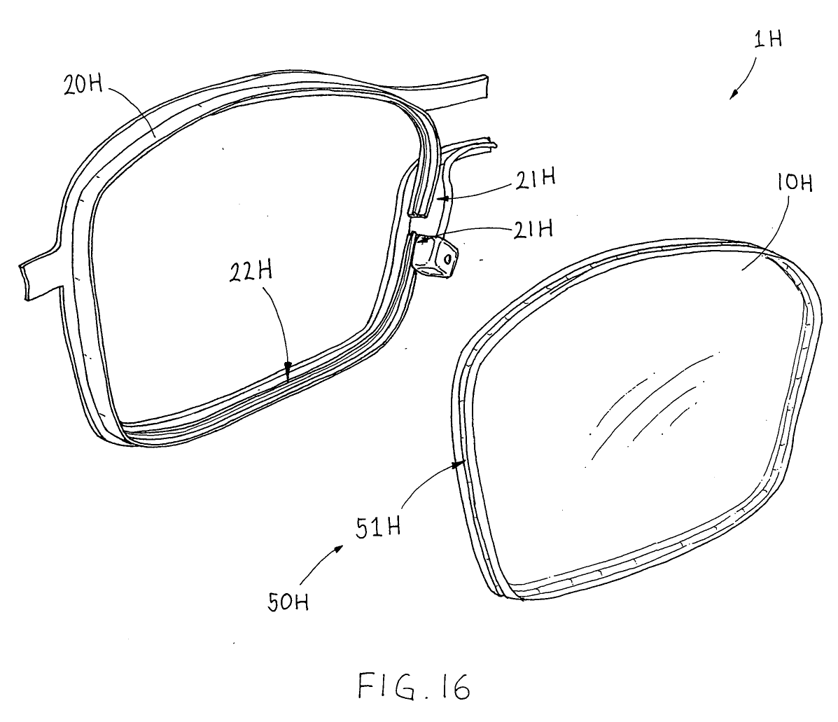

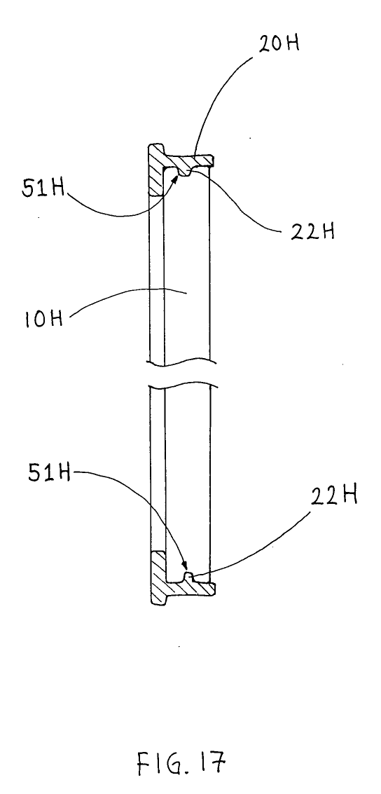

As shown in FIGS. 16 and 17, a spectacle set of an eighth embodiment illustrates another alternative mode of the fourth embodiment of the present invention, wherein the decorative frame 1H, having the same structure of the first embodiment expect the securing device 50H, comprises two lens rims 20H to hold the lenses 10H in position.

Each of the lens rims 20H having a C-shape has two free ends 21H arranged in such a manner that when the two free ends 21H are aligned with each other, the lens rim 20H form a circular structure to encircle a peripheral edge of the respective lens 10H.

Each of the lens rims 20H is shaped and sized corresponding to the lens 10H such that each of the lens rims 20H forms a circular structure to encircle the respective lens 10H. Each of the lens rims 20H having a L-shape cross section has a surrounding rim 22H encircling a peripheral edge of the respective lens 10H.

The securing device 50H contains a holding groove 51H formed along a peripheral edge of each of the lenses 10H, wherein the surrounding rim 22H is fittingly engaged in the respective holding groove 51H, as shown in FIG. 17, so as to mount the lens 10H within the respective lens rim 20H. Accordingly, each of the lens rims 20H can be slightly stretched to expand the size of the lens rim 20H such that the lens 10H is adapted to fit into the respective lens rim 20H to engage the surrounding rim 52H with the holding groove 51H.

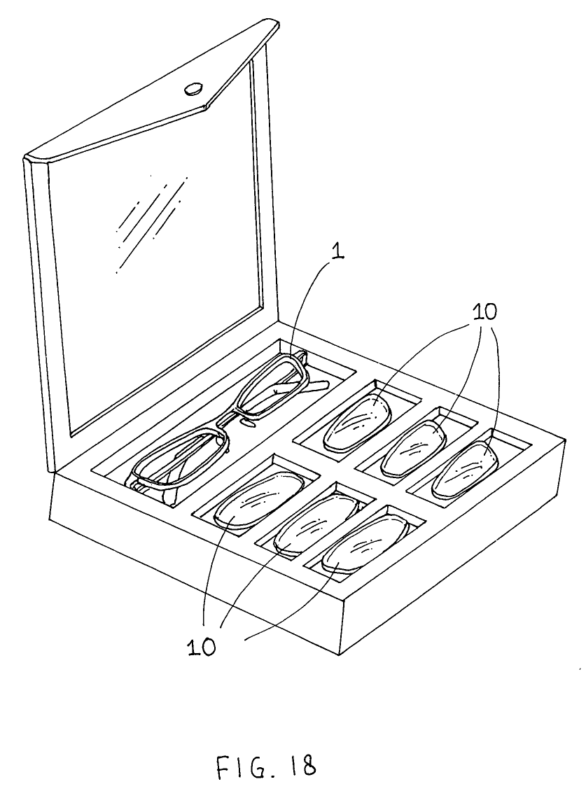

As shown in FIG. 18, the spectacle set of the present invention forms a lens interchangeable spectacle kit that the user is able to interchange the lenses 10 with one single decorative frame 1. In other words, the user can change different colors of lenses 10 without purchasing additional spectacle frame. Furthermore, no tool is required to detachably mount the lenses to the decorative frame 1 and the mounting operation of the lens 10 is simple such that the user is able to replace the lenses 10 in seconds.

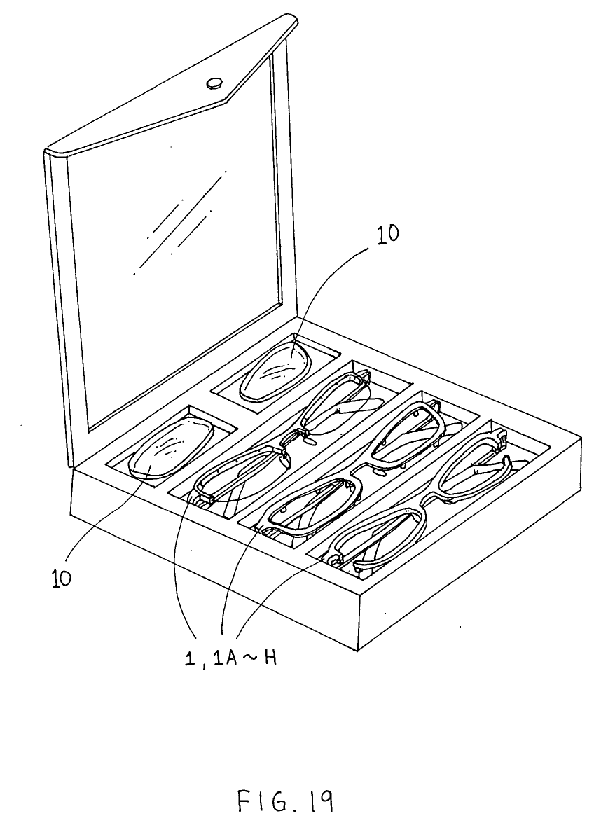

FIG. 19 illustrates another application of the spectacle set of the present invention, wherein a plurality of decorative frames 1, 1A though 1H are provided to detachably hold the lenses 10 in position, such that the user is able to interchange the decorative frames 1, 1A through 1H with the lenses 10, especially for the prescription lens.

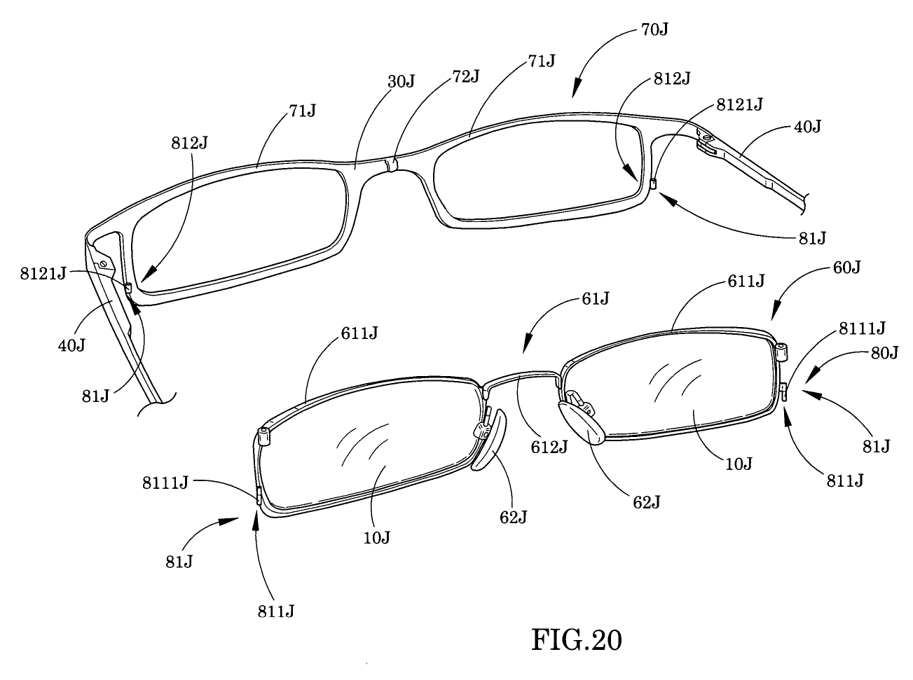

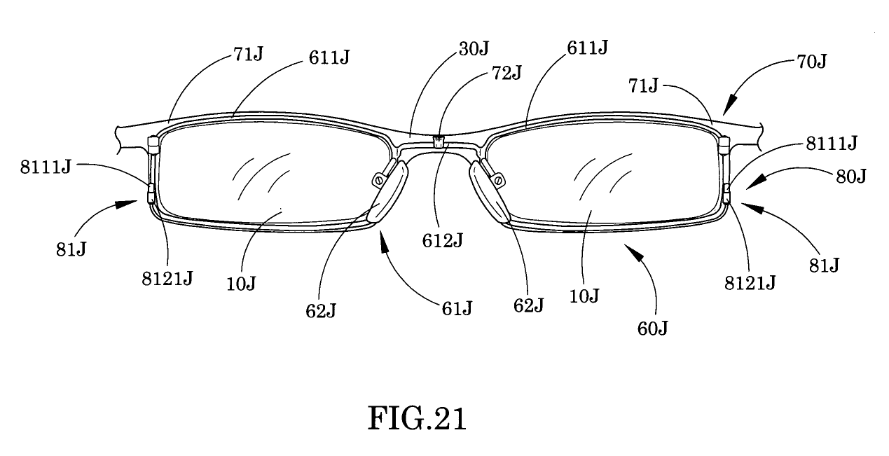

Referring to FIG. 20 to FIG. 21 of the drawings, a spectacles set according to a ninth preferred embodiment of the present invention is illustrated, in which the spectacles set comprises a lens frame 60J, at least a decorative frame 70J, and a lens engaging arrangement 80J.

The lens frame 60J comprises two lenses 10J and a lens retention arrangement 61J spacedly supporting the two lens 10J in position.

The decorative frame 70J comprises two lens rims 71J defining two lens areas respectively, a bridge 30J extending between two inner sides of the lens rims 71J, and two side extensions 40J extending at two outer sides of the lens rims 71J.

The lens engaging arrangement 80J is provided at a rear side of the decorative frame 70J to detachably engage with the lens frame 60J at a position that when the lens retention arrangement 61J is detachably mounted at the rear side of the decorative frame 70J in a hidden manner, the two lenses 10J are alignedly positioned at two lens areas respectively so as to keep an aesthetic appearance of the decorative frame 70J with the two lenses 10J.

According to the ninth preferred embodiment of the present invention, the lens retention arrangement 61J of the lens frame 60J comprises two lens retention rim 611J partially or completely extending along peripheral edges of the two lenses 10J respectively, and a lens retention bridge 612J integrally extended between two inner side edges of the lens retention rims 611J respectively for connecting the two retention rims 61J and the two lenses 10J in a rigid and secure manner. According to the ninth preferred embodiment of the present invention, each of the lens retention rims 611J is arranged to surround the entire peripheral edge of the respective lens 10J so as to constitute a ‘full lens frame 60J’ for the lenses 10J.

The decorative frame 70J is arranged to cover the lens frame 60J so that the lens frame 60J can be hidden behind the decorative frame 70J for optimal aesthetic appearance of the spectacles set of the present invention. Accordingly, the lens rim 71 J of the decorative frame 70J has a width larger than that of the lens retention rim 611J so that when the lens frame 60J is mounted behind the decorative frame 70J, the lens frame 60J is substantially shielded by the decorative frame 70J so as to be mounted in a hidden manner.

The lens engaging arrangement 80J comprises a first and a second engaging unit 81J each of which comprises a first engaging connector 811J provided on the lens frame 60J and a second engaging connector 812J provided at a corresponding position on the decorative frame 70J, wherein the first engaging connector 811J is adapted to detachably engage with the second engaging connector 812J so as to detachably mount the lens frame 60J behind the decorative frame 70J in such a manner that the two lenses 10J are well-aligned with the two lens areas respectively.

More specifically, each of the first engaging connectors 811J comprises an engaging arm 8111J outwardly extended from a bottom portion of the outer edge of the corresponding lens retention rim 611J for detachably engaging with the corresponding second engaging connector 812J. Similarly, each of the second engaging connectors 812J comprises a retention sleeve 8121J, having a through retention slot formed therein, rearwardly and integrally extended from a bottom portion of a rear side of the corresponding lens rim 71J, so that each of the engaging arms 8111J is arranged to slidably insert into the through retention slot of the respective retention sleeve 8121J so as to detachably engage the lens frame 61J on the decorative frame 70J at a rear side thereof.

In other words, the lens frame 60J comprises the two lens retention rims 611J encirclingly extending along peripheral edges of the two lenses 10J respectively, and a lens retention bridge 612J integrally extended between two inner sides of the lens retention rims 611J, wherein two engaging arms 8111J are integrally formed at two outer sides of the lens retention rims 611J to detachably engage with the retention sleeve 8121J to detachably mount the lens frame 60J behind the decorative frame 70J.

According to the ninth preferred embodiment of the present invention, each of the engaging arms 8111J has a L-shaped cross section having a transverse portion outwardly extended corresponding lens retention rim 611J, and a longitudinal portion, which is spacedly apart from the lens retention rim 611J, downwardly extended from the transverse portion for inserting into the corresponding retention sleeve 8121J. As a result, a length of the longitudinal portion of the engaging arm 8111J is longer than a height of the corresponding retention sleeve 8121J. Similarly, a width of the longitudinal portion of the engaging arm 8111J is slightly less than a diameter of the retention slot of the retention sleeve 8121J, so that when the engaging arm 8111J is inserted into the retention sleeve 8121J, a lateral movement between the lens frame 60J and the decorative frame 70J is substantially restricted.

The decorative frame 70J further comprises a positioning member 72J rearwardly extended from the bridge 30J for mounting the lens retention bridge 612J of the lens retention arrangement 61J when the lens frame 60J is detachably mounted on the decorative frame 70J. More specifically, the positioning member 72J comprises a clipping hanger rearwardly extended from the bridge 30J to ride on the lens retention bridge 612J for securing a position, notably an upward movement, of the lens frame 60J with respect to the decorative frame 70J. Accordingly, the two engaging arms 8111J are extended from the lens retention rims 611J respectively at a position below the positioning member 72J.

The lens frame 60J further comprises a pair of nose pieces 62J rearwardly extended from the inner sides of the lens retention rims 611J respectively for resting on a user's nose when the spectacle set of the present invention is worn on the user's face. It is then worth mentioning that since the relative position of the lenses 10J is substantially fixed, as a result, the lenses 10J can be pre-adjusted to fit the user's eye (e.g. the focal distance of the eyes) while the user could replace the aesthetic appearance of the spectacle set by simply changing the decorative frame 70J without affecting the prescription or positions of the lenses 10J. In other words, the lenses 10J as retained by the lens frame 60J are always suitable for the user's eyes, irrespective of which decorative frame 70J has been picked by the user of the present invention.

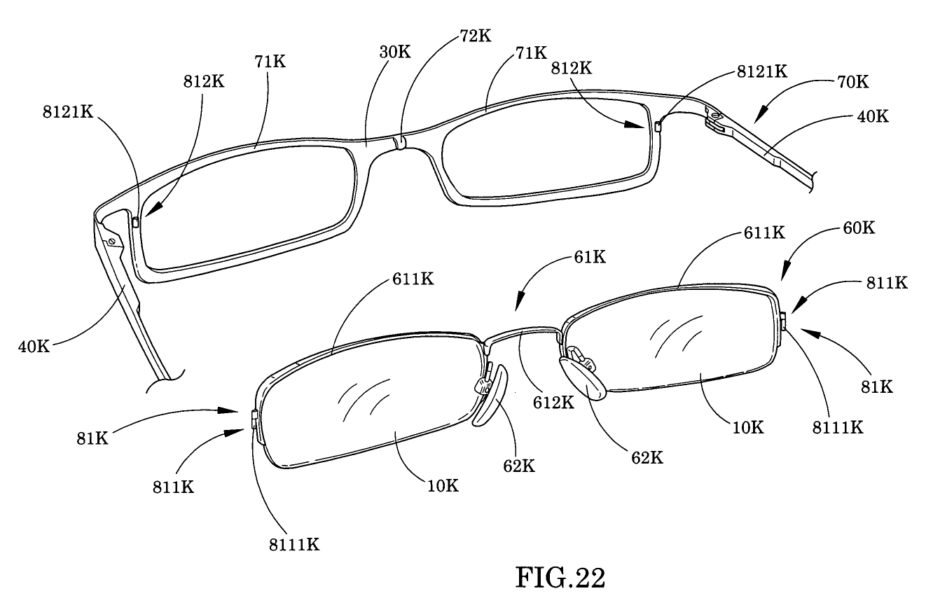

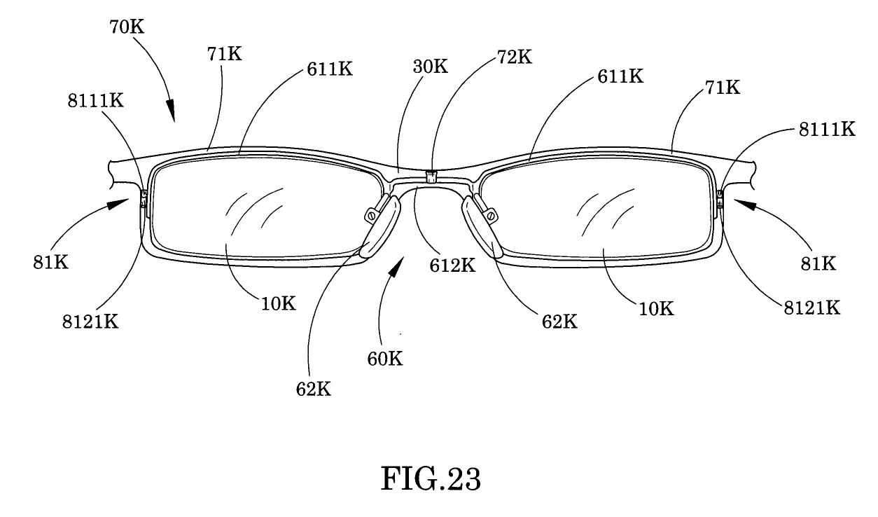

Referring to FIG. 22 to FIG. 23 of the drawings, a first alternative mode of the spectacles set according to the ninth preferred embodiment of the present invention is illustrated. The first alternative mode is similar to the ninth preferred embodiment except the lens frame 60K. According to the first alternative mode, the lens retention rims 611K of the lens retention arrangement 61K partially surrounds the peripheral edge of the lenses 10K respectively so as to define a ‘half-lens frame 60K’ of the present invention. More specifically, each of the lens retention rims 611K surrounds only an upper half portion of the respective lens 10K with the lens retention bridge 612K extending across two inner sides of the lens retention rims 611K. Accordingly, the first engaging connector 811K (the engaging arms 8111K) of the first and second engaging units 81K is formed at an upper side of the outer edge of the lens frame 60K, whereas the second engaging connectors 812K (retention sleeve 8121K) of the first and the second engaging units 81K is formed on an upper portion of the rear side of the lens rims 71K of the decorative frame 70K respectively, wherein the bridge 30K is extending across the lens rims 71K. Moreover, as in the ninth preferred embodiment, the positioning member 72K is rearwardly extended from the bridge 30K. The lens frame 60K also comprises the side extensions 40K and the nose pieces 62K.

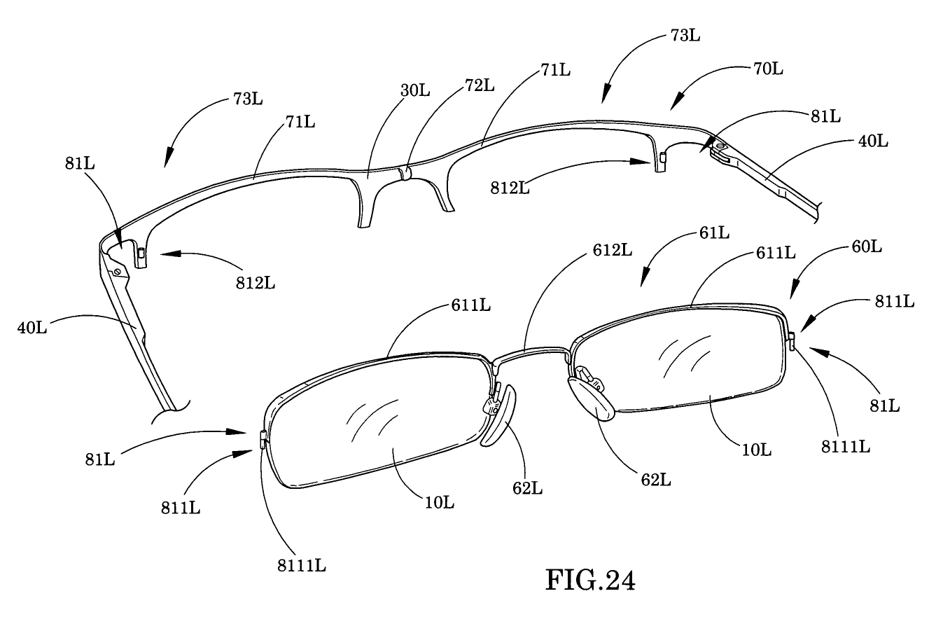

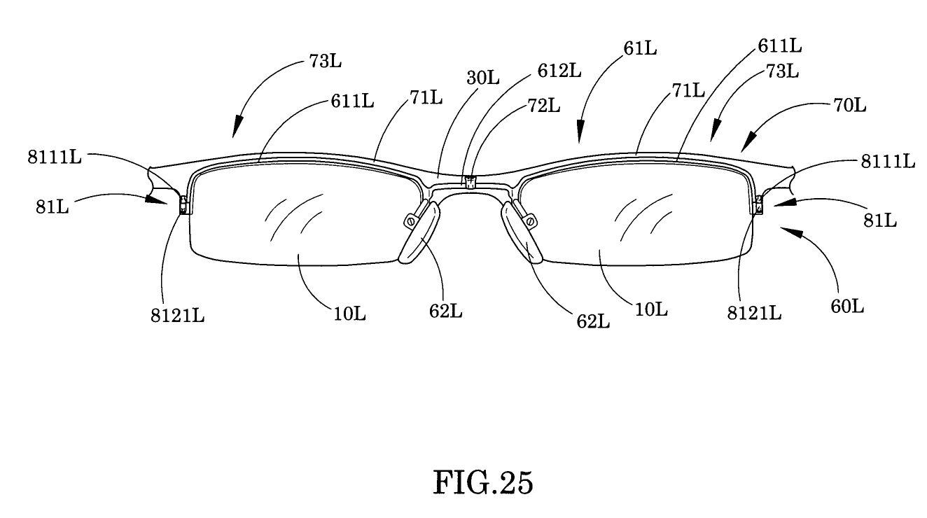

Referring to FIG. 24 to FIG. 25 of the drawings, a second alternative mode of the spectacles set according to the ninth preferred embodiment of the present invention is illustrated. The second alternative mode is similar to the ninth preferred embodiment except the decorative frame 70L. According to the second alternative mode, the lens retention rims 611L of the lens retention arrangement 61L of the lens frame 60L partially surrounds the peripheral edge of the lenses 10L respectively so as to define a ‘half-lens frame’ of the present invention. More specifically, each of the lens retention rims 611L surrounds only an upper half portion of the respective lens 10L with the lens retention bridge 612L extending across two inner sides of the lens retention rims 611L.

Accordingly, the first engaging connector 811L (the engaging arms 8111L) of the first and second engaging units 81L is formed at an upper side of the outer edge of the lens frame 60L, whereas the second engaging connectors 812L (retention sleeve 8121L) of the first and the second engaging units 81L is formed on an upper portion of the rear side of the lens rims 71L of the decorative frame 70L respectively, wherein the bridge 30L is extending across the lens rims 71L. Moreover, as in the ninth preferred embodiment, the positioning member 82L is rearwardly extended from the bridge 30L.

As a result, according to the second alternative mode of the present invention, the lens rims 71L of the decorative frame 70L is designed to shield the lens retention rims 611L respectively so that half (i.e. the bottom portion) of the lenses 10L are left ‘rimless’ by the lens frame 60L as well as the decorative frame 70L. The lens frame 60K also comprises the side extensions 40L and the nose pieces 62L.

In other words, the lens rim 71L of the decorative frame 70L comprises two L-shaped decorative arms 73L adapted for extending along a upper half portion of the lenses 10L respectively, and a bridge 30L extended between two inner ends of the decorative arms 73L for forming an integral decorative frame 70L. The positioning member 72L is then rearwardly extended from the bridge 30L to ride on the lens retention bridge 612L of the lens frame 60L.

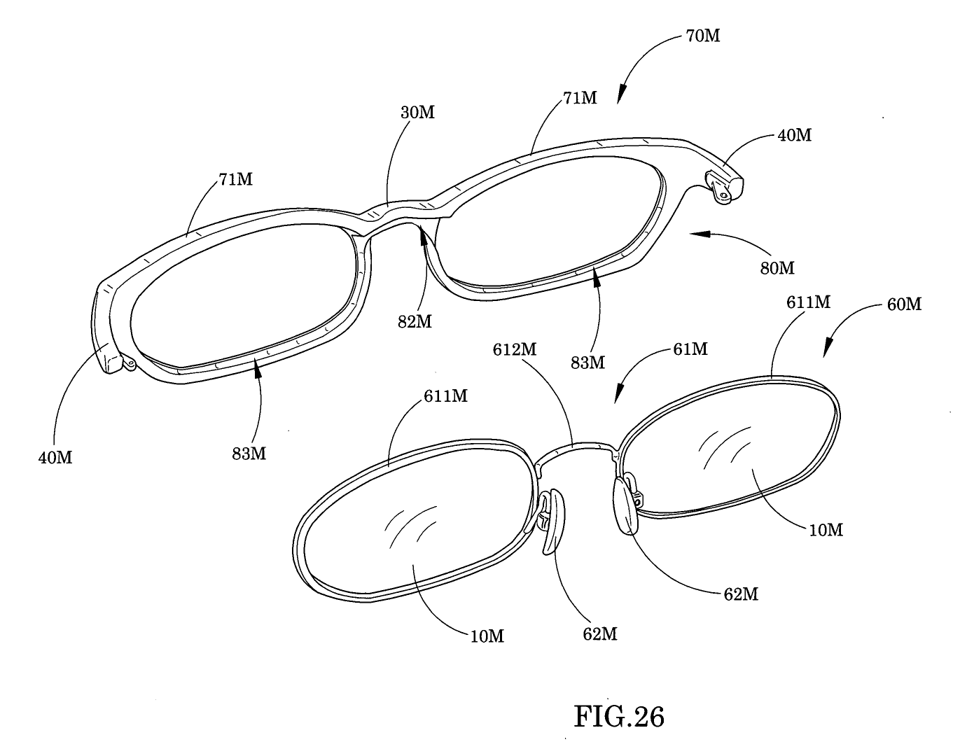

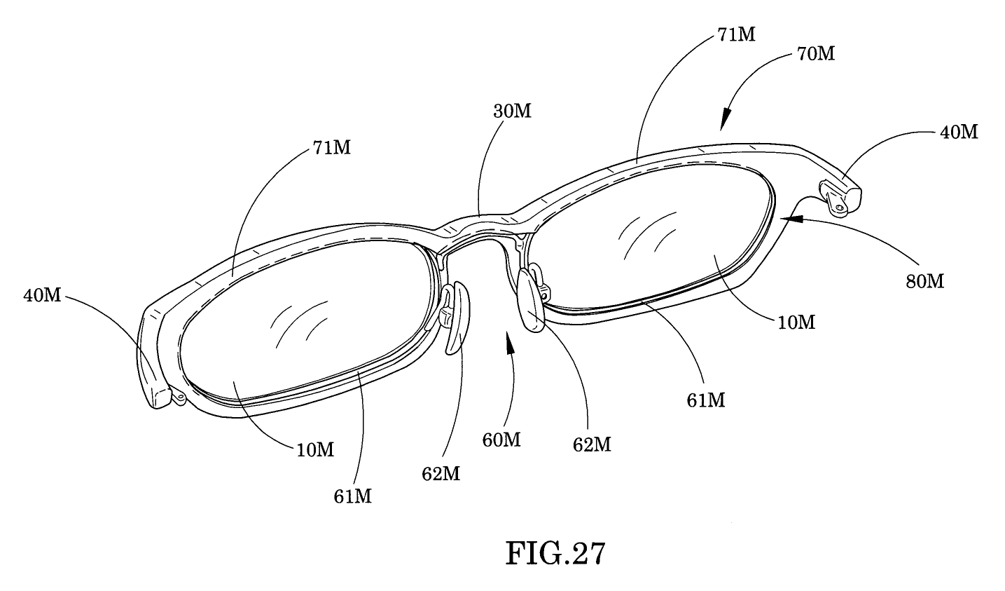

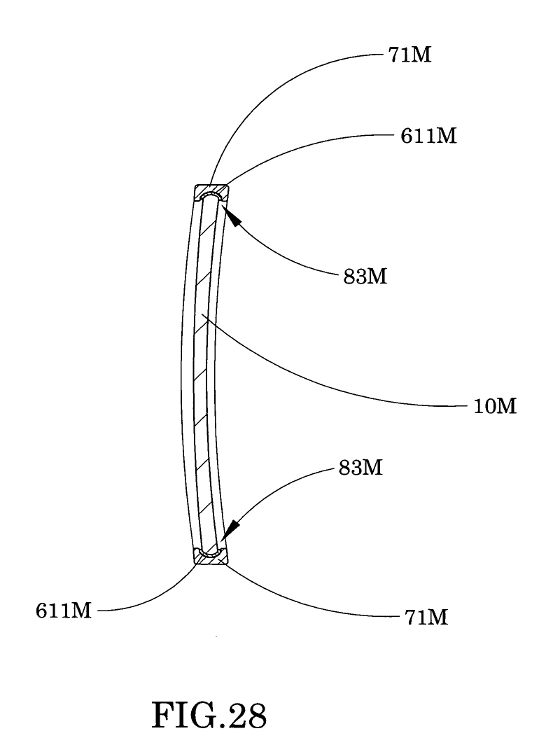

Referring to FIG. 26 to FIG. 28 of the drawings, a spectacles set according to a tenth preferred embodiment of the present invention is illustrated, in which the spectacles set comprises a lens frame 60M, at least a decorative frame 70M, and a lens engaging arrangement 80M.

The lens frame 60M comprises two lenses 10M and a lens retention arrangement 61M spacedly supporting the two lens 10M in position.

The decorative frame 70M, which comprises two lens rims 71M defining two lens areas respectively, a bridge 30M extending between two inner sides of the lens rims 71M, and two side extensions 40M extending at two outer sides of the lens rims 71M. The lens frame 60M also comprises two nose pieces 62M mounted underneath the bridge 30M.

The lens engaging arrangement 80M is provided at a rear side of the decorative frame 70M to detachably engage with the lens frame 60M at a position that when the lens retention arrangement 61 M is detachably mounted at the rear side of the decorative frame 70M in a hidden manner, the two lenses 10M are alignedly positioned at two lens areas respectively so as to keep an aesthetic appearance of the decorative frame 70M with the two lenses 10M.

According to the tenth preferred embodiment, the lens retention arrangement 61M of the lens frame 60M comprises two lens retention rim 611M partially or completely extending along peripheral edges of the two lenses 10M respectively, and a lens retention bridge 612M integrally extended between two inner side edges of the lens retention rims 611M respectively for connecting the two retention rims 611M and the two lenses 10M in a rigid and secure manner. According to the tenth preferred embodiment of the present invention, each of the lens retention rims 611M is arranged to surround the entire peripheral edge of the respective lens 10M so as to constitute a ‘full frame’ of the lenses 10M.

The decorative frame 70M is arranged to cover the lens frame 60M so that the lens frame 60M can be hidden behind the decorative frame 70M for optimal aesthetic appearance of the spectacles set of the present invention. Accordingly, the lens rim 71M of the decorative frame 70M has a width larger than that of the lens retention rim 611M so that when the lens frame 60M is mounted behind the decorative frame 70M, the lens frame 60M is substantially shielded by the decorative frame 70M so as to be mounted in a hidden manner. It is important to point out that the decorative frame 70M is made of plastic materials so as to resemble plastic spectacles for the lenses 10M.

The lens engaging arrangement 80M contains a mounting slot 82M which is indently formed along the bridge 30M of the decorative frame 70M at the rear side thereof the lens rim 71M and is arranged in such a manner that when the lens retention bridge 612M of the lens frame 60M is detachably engaged with the mounting slot 82M, the lens frame 60M is detachably mounted behind the decorative frame 70M.

The lens engaging arrangement 80M further contains two lens grooves 83M indently formed around the two lens rims 71 M of the decorative frame 70M respectively to communicatively extend between the mounting slot 82M, wherein the two lens retention rims 611M are detachably engaged within the two lens grooves 83M respectively when the lens retention bridge 612M of the lens frame 60M is detachably engaged with the mounting slot 82M, so as to embed the lens frame 60M behind the decorative frame 70M.

Since the decorative frame 70M is made by plastic materials having a predetermined flexibility, the decorative frame 70M normally exerts an urging force towards the lens frame 60M for normally retaining it being mounted within the mounting slot 82M. As a result, a contour of the mounting slot 82M is substantially the same as the contour of the lens frame 60M so as to allow for fit engagement between the lens frame 60M and the decorative frame 70M.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A spectacles set, comprising:
a lens frame which comprises two lenses and a lens retention arrangement spacedly supporting said two lens in position;
at least a decorative frame, which comprises two lens rims defining two lens areas respectively, a bridge extending between two inner sides of said lens rims, and two side extensions extending at two outer sides of said lens rims; and
a lens engaging arrangement provided at a rear side of said decorative frame to detachably engaging with said lens frame at a position that when said lens retention arrangement is detachably mounted at said rear side of said decorative frame in a hidden manner, said two lenses are alignedly positioned at two lens areas respectively so as to keep an aesthetic appearance of said decorative frame with said two lenses alignedly mounting thereto.

2. The spectacles set, as recited in claim 1, wherein said lens engaging arrangement comprises two retention sleeves integrally formed at two outer sides of said decorative frame at said rear side thereof and two engaging arms which are outwardly and downwardly extended from said two outer sides of said lens frame respectively and are arranged to slidably insert into said two retention sleeves respectively so as to detachably mount said lens frame behind said decorative frame.

3. The spectacles set, as recited in claim 2, wherein each of said engaging arms has a L-shaped cross section having a transverse portion sidewardly extended from said decorative, and a longitudinal portion downwardly extended from said transverse portion to insert into said corresponding retention sleeve, such that when said longitudinal portions of said engaging arms are respectively inserted into said retention sleeves, a lateral movement between said lens frame and said decorative frame is substantially restricted.

4. The spectacles set, as recited in claim 2, wherein said lens frame comprises two lens retention rims encirclingly extending along peripheral edges of said two lenses respectively and a lens retention bridge integrally extended between two inner sides of said lens retention rims, wherein said two engaging arms are integrally formed at two outer sides of said lens retention rims to detachably engage with said retention sleeve to detachably mount said lens frame behind said decorative frame.

5. The spectacles set, as recited in claim 3, wherein said lens frame comprises two lens retention rim encirclingly extending along peripheral edges of said two lenses respectively and a lens retention bridge integrally extended between two inner sides of said lens retention rims, wherein said two engaging arms are integrally formed at two outer sides of said lens retention rims to detachably engage with said retention sleeve to detachably mount said lens frame behind said decorative frame.

6. The spectacles set, as recited in claim 4, wherein said lens engaging arrangement further comprises a positioning member rearwardly extended from said bridge to ride on said lens retention bridge for securing a position of said lens frame with respect to said decorative frame.

7. The spectacles set, as recited in claim 5, wherein said lens engaging arrangement further comprises a positioning member rearwardly extended from said bridge to ride on said lens retention bridge for securing a position of said lens frame with respect to said decorative frame.

8. The spectacles set, as recited in claim 6, wherein said two engaging arms are extended from said lens retention rims respectively at a position below said positioning member.

9. The spectacles set, as recited in claim 7, wherein said two engaging arms are extended from said lens retention rims respectively at a position below said positioning member.

10. The spectacles set, as recited in claim 3, wherein said lens retention rims entirely surrounds said peripheral edge of said lenses respectively so as to define a ‘full-lens frame’ of said respective lens, wherein said lens retention bridge is extended across two inner sides of said lens retention rims, wherein said lens rim of said decorative frame has a width larger than that of said lens retention rim so that when said lens frame is mounted behind said decorative frame, said lens frame is substantially shielded by said decorative frame so as to mount lens frame behind said decorative frame in said hidden manner.

11. The spectacles set, as recited in claim 7, wherein said lens retention rims entirely surrounds said peripheral edge of said lenses respectively so as to define a ‘full-lens frame’ of said respective lens, wherein said lens retention bridge is extended across two inner sides of said lens retention rims, wherein said lens rim of said decorative frame has a width larger than that of said lens retention rim so that when said lens frame is mounted behind said decorative frame, said lens frame is substantially shielded by said decorative frame so as to mount lens frame behind said decorative frame in said hidden manner.

12. The spectacles set, as recited in claim 9, wherein said lens retention rims entirely surrounds said peripheral edge of said lenses respectively so as to define a ‘full-lens frame’ of said respective lens, wherein said lens retention bridge is extended across two inner sides of said lens retention rims, wherein said lens rim of said decorative frame has a width larger than that of said lens retention rim so that when said lens frame is mounted behind said decorative frame, said lens frame is substantially shielded by said decorative frame so as to mount lens frame behind said decorative frame in said hidden manner.

13. The spectacles set, as recited in claim 3, wherein said lens retention rims partially surrounds said peripheral edge of said lenses respectively so as to define a ‘half-lens frame’ at an upper half portion of said respective lens, wherein said lens retention bridge is extended across two inner sides of said lens retention rims, wherein said lens rim of said decorative frame has a width larger than that of said lens retention rim so that when said lens frame is mounted behind said decorative frame, said lens frame is substantially shielded by said decorative frame so as to mount lens frame behind said decorative frame in said hidden manner.

14. The spectacles set, as recited in claim 7, wherein said lens retention rims partially surrounds said peripheral edge of said lenses respectively so as to define a ‘half-lens frame’ at an upper half portion of said respective lens, wherein said lens rim of said decorative frame has a width larger than that of said lens retention rim so that when said lens frame is mounted behind said decorative frame, said lens frame is substantially shielded by said decorative frame so as to mount lens frame behind said decorative frame in said hidden manner.

15. The spectacles set, as recited in claim 9, wherein said lens retention rims partially surrounds said peripheral edge of said lenses respectively so as to define a ‘half-lens frame’ at an upper half portion of said respective lens, wherein said lens rim of said decorative frame has a width larger than that of said lens retention rim so that when said lens frame is mounted behind said decorative frame, said lens frame is substantially shielded by said decorative frame so as to mount lens frame behind said decorative frame in said hidden manner.

16. The spectacles set, as recited in claim 1, wherein said decorative frame is made of plastic, wherein said lens frame comprises two lens retention rims encirclingly extending along peripheral edges of said two lenses respectively and a lens retention bridge integrally extended between two inner sides of said lens retention rims, wherein said lens frame is embedded on said rear side of said decorative frame.

17. The spectacles set, as recited in claim 16, wherein said lens engaging arrangement contains a mounting slot which is indently formed along said bridge of said decorative frame at said rear side thereof said lens rim and is arranged in such a manner that when said lens retention bridge of said lens frame is detachably engaged with said mounting slot, said lens frame is detachably mounted behind said decorative frame.

18. The spectacles set, as recited in claim 17, wherein said lens engaging arrangement further contains two lens grooves indently formed around said two lens rims of said decorative frame respectively to communicatively extend between said mounting slot, wherein said two lens retention rims are detachably engaged within said two lens grooves respectively when said lens retention bridge of said lens frame is detachably engaged with said mounting slot, so as to embed said lens frame behind said decorative frame.

19. The spectacles set, as recited in claim 17, wherein said lens rim of said decorative frame has a width larger than that of said lens retention rim so that when said lens frame is mounted behind said decorative frame, said lens frame is substantially shielded by said decorative frame so as to mount lens frame behind said decorative frame in said hidden manner.

20. The spectacles set, as recited in claim 18, wherein said lens rim of said decorative frame has a width larger than that of said lens retention rim so that when said lens frame is mounted behind said decorative frame, said lens frame is substantially shielded by said decorative frame so as to mount lens frame behind said decorative frame in said hidden manner.
